(19) United States
(12) Patent Application Publication
(10) Pub. No.: US 2007/0144401 A1
(43) Pub. Date: Jun. 28, 2007

(54) Slurriers containing iron compound used in the casting of metals

(76) Inventor: Kenneth Miller Peter Harris, Asker (NO)

Correspondence Address: JACOBSON HOLMAN PLLC, 400 SEVENTH STREET N.W., SUITE 600, WASHINGTON, DC, 20004, US

(21) Appl. No.: 10/569,079

(22) PCT Filed: Aug. 23, 2004
(86) PCT No.: PCT/US04/27363

§ 371 Date: Dec. 4, 2006

Related U.S. Application Data
(60) Provisional application No. 60/496,674, filed on Aug. 21, 2003.

(51) Int. Cl. C04B 35/66

(52) U.S. Cl. 106/38.22

(57) ABSTRACT

Slurries containing tri-or polyvalent cations are used for investment casting and making molds as well as core coatings. These slurries are aqueous or alcohol-based containing a mineral component and a polyanionic binder, where at least one of the continuous phase or mineral component contains trivalent or polyvalent cations or cations that are converted into trivalent or polyvalent cations during use. The cationic component is selected from a group consisting of at least one of the metals iron or aluminum. The polyanionic component contains at least one of the group consisting of colloidal silica or one or more water-soluble organic polymers.

### DESCRIPTION OF INVESTMENT CASTING TECHNIQUES

Investment casting is a process for making finely detailed parts, which entails making a model of the item to be cast in a material such as wax or expanded polystyrene foam that can be melted at temperatures of between 50 and 150° C., and then forming a coating, the shell, around the model by repeated applications of a slurry containing a mineral component and a binder, the latter being typically based upon colloidal silica.

The shell-building process typically begins with the manufacture of a thin shell consisting of a finely divided aggregate, typically of particle size below 75 μm. This primary shell is strengthened by applying additional layers of coating upon it and by further applications of slurries that may containing coarser aggregates, after which the whole is heated in two stages. The first stage dries the shell and melts the wax or foam model underneath. For this reason the process is also known as the lost wax or lost foam process.

In the lost wax process, the wax runs out leaving the dried “green” shell that is then fired at a temperature of 600° C. or more to both yield a strong, ceramic shell into which metal is poured to burn away any residual wax.

The process for making lost foam investment casting mould is similar but the shell is simpler in construction and thinner, being held in place by a bed of compacted sand. In contrast to the lost wax process the model is made of a foamed polymer, usually expanded polystyrene, which shrinks when the shell is dried but remains inside it instead of running out as is the case with the lost wax process. The foam residues are then burnt away when the molten metal is poured into the mold.

It is extremely important that the slurry is capable of forming a strong green shell that can be handled without breaking and does not contain components that can evolve gases that can crack the shell during fning. Similarly, it is important that the final shell is strong enough to withstand the stresses incurred during metal casting.

The silicic acid sol is one of the very few binders that can provide these properties and the only binder of significance used for the purpose. It is however extremely sensitive to chemical impurities and requires that other components used with it be extremely pure. As an example, it is recommended that only deionised water be used in the manufacture of slurries. A similar situation pertains to the mineral component, one of the most common being a chemically pure aluminium silicate made by fusing pure alumina and pure silica together and then crushing and sieving the resultant product. Other minerals used for making shells include zircon (zirconium silicate), mullite (natural aluminium silicate) and powdered fused silica.

All these requirements combine make investment casting a most expensive process that is used only for the most demanding parts. The paucity of suitable minerals precludes or at least severely limits the use of a number of potentially valuable processes that could help reduce costs.

One of these, microwave heating, has been the object of considerable interest, since it heats the slurries more rapidly than convective heating, allowing the shell to be dried and the wax or foam to melted more rapidly.

For this reason, the industry has also been studying the use of components, particularly model waxes, that can absorb microwave energy and thus are heated to their melting point more quickly in a microwave oven than do standard waxes in atypical convection oven. Whilst efficient in this respect, these waxes, often containing small droplets of water emulsified within the wax, are more difficult and costly to reclaim.

Even more significant are the savings that can be achieved if it is possible to use minerals for making shells that could be heated to the green state and then fired by being subjected to an electromagnetic field, for example by microwaves or induction methods. Such minerals are described in U.S. provisional patent appl. 60/496,675 and include compounds of transition metal elements (iron, cobalt and nickel) in the divalent state, such as norite (iron calcium aluminosilicate) ilnenite (iron titanate), chromite (iron chromite), oivine (ferruginous magnesium silicate), magnetite (iron sesquioxide), hyperite (iron magnesium aluminosilicate).

Attempts to use these minerals in conventional slurries for investment casting or mold coating together with polyanionic binders such as colloidal silica purposes fail due to gelation of the binder.

### DETAILED DESCRIPTION OF THE PREFERRED EMBODIMENT

Shells for Light Metal Casting

This invention describes how slurries containing ferruginous minerals, including those that can be heated by electromagnetic fields (EMF), can be stabilised and used to manufacture shells that are more cost effective and versatile than the state of the art products.

The fact that slurries containing ferruginous minerals and polyanionic binders are unstable proscribes their use for investment casting. This phenomenon is not adequately explained in the literature, although suppliers of products used for these purposes do state maximum levels for iron content, typically less than 200ppm.

It is therefore unexpected that the stability of slurries having far greater iron contents than this can be used by the expedient of adding at least 0.2% by weight of a reducing agent such as sodium hypophosphite to the binder system. A similar effect was also found upon the addition of at least 0.2% of e.g. diammonium hydrogen phosphate and particularly trisodium phosphate. It was also found that mixtures of stabilisers such as these could be used with similar effect.

As an example, the following slurry can be used as a primary coat for lost wax investment casting of aluminium:

TABLE 1
Primary coating, light metal casting

| Component | Function | Quantity |
|---|---|---|
| Remet LP¹ | Silica sol binder | 28% |
| Adbond Ultra¹ | Polymer latex | 7% |
| Victawet 12² | Antifoam | 0.6% |
| Burst RSD10³ | Wetting agent | 0.3% |
| Trisodium | Stabiliser | 4% by weight |
| orthophosphate | | of mineral |
| −200 mesh norite⁴ | Mineral | 3.7 kg/kg |
| | | binder system |

¹Trademark of Remet Inc.
²Trademark of Akzo Nobel
³Trademark of Ciba-Geigy
⁴Iron calcium aluminosilicate as mined at Rekefjord, Norway

Also as an example, the following slurry can be used for the secondary coats:

TABLE 2
Secondary coating, light metal casting

| Component | Function | Quantity |
|---|---|---|
| Remet LP¹ | Silica sol binder | 22% |
| Adbond BV¹ | Polymer latex | 10% |
| Burst RSD10³ | Wetting agent | 0.5% |
| Trisodium | Stabiliser | 2% by weight |
| orthophosphate | | of mineral |
| −200 mesh norite⁴ | Mineral | 2.2 kg/kg |
| | | binder system |

¹Trademark of Remet Inc.
²Trademark of Akzo Nobel
³Trademark of Ciba-Geigy
⁴Iron calcium aluminosilicate as mined at Rekefjord, Norway

In all cases it is advisable that the trisodium orthophosphate is dissolved in the binder before the mineral is added. A coarser norite, for example 35/50 mesh, can then be rained onto this secondary coat to provide a finished layer consisting 87.5% secondary slurry and 12.5% coarser norite.

There are a number of significant advantages for this system over conventional systems.

Firstly, the higher thermal conductivity of ferruginous shells allows them to be dried and dewaxed in standard equipment (autoclave) in less than half the time required for shells made with conven-tional systems, thereby increasing the efficiency of the process and reducing its energy needs.

Secondly, drying and dewaxing can be carried out even more quickly by microwave or induction heating in a circulating air oven, by which process residual wax can be removed before firing.

Thirdly, these shells can be fired by induction or microwave methods far more rapidly and with far lower energy requirement than in a conventional hot air oven.

Fourthly, tap water can be used to manufacture slurries containing trisodium or tripotassium phosphate, without the concurrent instability that can affect state of the art slurries. This represents a considerable saving, since foundries using conventional systems are obliged to use deionised water, which many need to purchase at a price that reflects both manufacturing and transport costs.

Fifthly, the specific use of trisodium or tripotassium phosphate yields slurries that have remarkably stable pH values. This is not the case for conventional slurries that often require adjustment with caustic soda or potash, with all that this implies in terms of monitoring and labor requirements.

Shells made in this way are suitable for investment casting of aluminium and other alloys cast at temperatures below 1,200° C.

It is possible that addition of chelating agents, reductants or phosphates together with ferruginous substances, including those that might be present in tap water, work by counteracting the deleterious effects of trivalent cations by reducing them to divalent cations or converting them to compounds so insoluble that they interact minimally with polyanionic binders. Divalent cations such as Fe²⁺ do not destabilise these binders but do so rapidly when oxidised to the trivalent state.

Investment Casting Shells for Ferrous Metals

The method of the invention can also be used to make ceramic shells for iron casting by the lost foam process or steel casting by the lost foam or lost wax processes, using a mineral such as olivine containing less than 8% iron.

Where systems sensitive to microwave or induction energy fields are desired, elemental carbon can be added to the secondary coat for example in the ratio mixture 25% finely divided graphitic carbon and 75% olivine having a maximum iron content of 8%. Other minerals that do not form low melting point compounds with the silica binder, such as zircon and dicalcium orthosilicate, can be used instead of olivine. The shell must then be heated in an oxygen free environment.

Prior Art Techniques for Manufacturing Coatings for Foundry Molds and Cores

Molds and cores are often coated in order to improve the surface finish of casting or to help prevent metal penetration. A coating is a slurry that contains a finely milled mineral, often zircon, and a substance such as bentonite that is able to provide some bond strength also at casting temperatures. It is important that these coating slurries remain stable for many months, since they are typically supplied as ready-made products that are stored until use by the foundry.

Whilst foundries have, for many years, used alcohol based coatings that allow the continuous phase to be burnt off without needing to be dried, recent environmental legislation has decreed that the use of volatile organic liquid be restricted. Considerable efforts are now being made to replace alcohol with water based coatings and colloidal silica binders are in many ways ideal for this application, since they maintain their integrity during casting and are inexpensive. They are however hardly used due to poor storage stability and the fact that they are restricted to a limited range of minerals.

Coatings for Molds and Cores

Following the premises described here as a possible cause for the stability limitations of coatings based upon colloidal silica, the formulations given in the subsection entitled “Shells for light metal casting” and “Investment casting shells for ferrous metal” above have shown themselves to be well suited for use as mold and core coatings. The following systems are examples of satisfactory products, showing little change after storage for 6 months at 30° C.:

TABLE 3
Coating for molds and cores, light metal casting

| Component | Function | Quantity |
|---|---|---|
| Remet LP¹ | Silica sol binder | 22% |
| Adbond BV¹ | Polymer latex | 10% |
| Burst RSD10³ | Wetting agent | 0.5% |
| Trisodium | Stabiliser | 2% by weight |
| orthophosphate | | of mineral |
| −200 mesh norite⁴ | Mineral | 2.2 kg/kg |
| | | binder system |

¹Trademark of Remet Inc.
²Trademark of Akzo Nobel
³Trademark of Ciba-Geigy
⁴Iron calcium aluminosilicate as mined at Rekefjord, Norway

TABLE 4
Coating for molds and cores, iron casting

| Component | Function | Quantity |
|---|---|---|
| Remet LP¹ | Silica sol binder | 22% |
| Adbond BV¹ | Polymer latex | 10% |
| Burst RSD10³ | Wetting agent | 0.5% |
| Trisodium | Stabiliser | 2% by weight |
| orthophosphate | | of mineral |
| −200 mesh anorthosite⁴ | Mineral | 2 kg/kg binder |

¹Trademark of Remet Inc.
²Trademark of Akzo Nobel
³Trademark of Ciba-Geigy
⁴A mineral in the feldspar family mined at Rekefjord, Norway

TABLE 5
Coating for molds and cores, steel casting

| Component | Function | Quantity |
|---|---|---|
| Remet LP¹ | Silica sol binder | 22% |
| Adbond BV¹ | Polymer latex | 10% |
| Burst RSD10³ | Wetting agent | 0.5% |
| Trisodium | Stabiliser | 1% by weight |
| orthophosphate | | of mineral |
| −200 mesh olivine⁴ | Mineral | 2.3 kg/kg |
| | | filler loading |

¹Trademark of Remet Inc.
²Trademark of Akzo Nobel
³Trademark of Ciba-Geigy
⁴Ferruginous magnesium silicate

The purpose of the polymer latex is to provide so-called green strength so that the coating does not crack during drying or movement of the mold or core. Coatings made with colloidal silica binders have exceptionally good hot strength and are highly refractory. It is not possible to manufacture stable water based coatings using minerals such as those named above, together with a colloidal silica or similar polyanionic binder, unless the method of this invention is followed.

One particular advantage of being able to use ferruginous minerals such as Norite in the manufacture of water based coatings, is that these can be dried rapidly by exposure to an oscillating electromagnetic impulse, such as a microwave or preferably an induction field. Whilst Norite is suitable for metals such as aluminium, more refractory minerals need to be used in coatings employed in iron and particularly steel casting. Some of these e.g. iron chromite and magnetite, are sufficiently refractory to be used in iron casting either alone or mixed with e.g. anorthosite.

However the temperatures experienced in steel casting may cause the silica in the binder to react with ferruginous minerals to form less refractory compounds such as fayelite (ferrous orthosilicate) or gruenerite (ferrous metasilicate), which may preclude the use of minerals containing more than 8% or so of ferrous compounds. However the addition of 3-30% or more graphitic carbon to a mineral with low iron content will usually generate sufficient heat in an oscillating electromagnetic field.

The foregoing description should be considered as illustrative only of the principles of the invention. Numerous applications of the present invention will readily occur to limit the invention to the preferred embodiments described above. Rather, all suitable modifications and equivalents may be resorted to, falling within the scope of the invention.

1. Slurries containing tri- or polyvalent cations used for investment casting and making molds and core coatings.

2. Aqueous and alcohol-based slurries according to claim 1, containing a mineral component and a polyanionic binder, where at least one of the continuous phase or the mineral component contains trivalent or polyvalent cations or cations that are converted to trivalent or polyvalent cations during use.

3. The slurries according to claim 2, wherein the cationic component is selected from the group consisting of at least one of the metals iron or aluminum.

4. The slurries according to claim 2 where the polyanionic component contains at least one of the group consisting of colloidal silica or one or more water-soluble organic polymers.

5. The slurries according to claim 1 made by incorporating at least 0.01% by weight of mineral or water of an agent that converts said cationic components in the slurry to substances that are incapable of flocculating polyanionic substances.

6. The slurries according to claim 2 made by incorporating at least 0.01% by weight of mineral or water of an agent that converts said cationic components in the slurry to substances that are incapable of flocculating polyanionic substances.

7. The slurries according to claim 3 made by incorporating at least 0.01% by weight of mineral or water of an agent that converts said cationic components in the slurry to substances that are incapable of flocculating polyanionic substances.

8. The slurries according to claim 4 made by incorporating at least 0.01% by weight of mineral or water of an agent that converts said cationic components in the slurry to substances that are incapable of flocculating polyanionic substances.

9. Agents according to claim 5 that contains at least one agent selected from the group consisting of a chelating agent or a reducing agent or a water-soluble phosphate.

10. The slurries according to claim 1 containing minerals or carbon that can be heated in an electromagnetic field selected from the group consisting of microwave, induction or radio frequency radiation.

11. The slurries according to claim 2 containing minerals or carbon that can be heated in an electromagnetic field selected from the group consisting of microwave, induction or radio frequency radiation.

12. The slurries according to claim 3 containing minerals or carbon that can be heated in an electromagnetic field selected from the group consisting of microwave, induction or radio frequency radiation.

13. The slurries according to claim 4 containing minerals or carbon that can be heated in an electromagnetic field selected from the group consisting of microwave, induction or radio frequency radiation.

14. The slurries according to claim 5 containing minerals or carbon that can be heated in an electromagnetic field selected from the group consisting of microwave, induction or radio frequency radiation.

15. The slurries according to claim 6 containing minerals or carbon that can be heated in an electromagnetic field selected from the group consisting of microwave, induction or radio frequency radiation.
